(19) United States
(12) Patent Application Publication
(10) Pub. No.: US 2025/0208751 A1
(43) Pub. Date: Jun. 26, 2025

(54) Operating system and operating method for virtual space or online meeting systems

(71) Applicant: Yuto Izawa, Tokyo (JP)

(72) Inventor: Yuto Izawa, Tokyo (JP)

(21) Appl. No.: 18/835,431

(22) PCT Filed: Feb. 3, 2023
(86) PCT No.: PCT/JP2023/003681

§ 371 Date: Mar. 13, 2025

(30) Foreign Application Priority Data
Feb. 3, 2022 (JP) 2022-015984

(51) Int. Cl. G06F 3/0484; G06F 3/16

(52) U.S. Cl. CPC G06F 3/0484; G06F 3/165

(57) ABSTRACT

One or more embodiments provide a virtual One or more embodiments provide a system for operating a virtual space or online meeting system, wherein in a state of communicating with two or more users, all communicating users have a selection means for selecting any user among the communicating users while transmitting images to the communicating users, an output means for outputting an optional sound source only to the selected user, and a receiving means for receiving information transmitted by a user not selected. Provided is an actuation system for a virtual space or online meeting system, comprising: output means for outputting an arbitrary sound source only to the selected user(s).

### FIELD

This application is based on JP2022-015984, filed in Japan on Feb. 3, 2022, claiming priority thereto, the disclosure of which is incorporated herein by reference in its entirety. The present invention relates to an operating system for a virtual space or online meeting system.

### BACKGROUND

### Description of the Related Art The statements in this section only provide background information on this disclosure and do not necessarily constitute prior art.

An example of an operating system for a virtual space or online meeting system is disclosed in Patent Document No. 2010-006035 (Patent Document 1). Patent document 1 discloses an information management device for managing information of an avatar in a metaverse, characterized by static information acquisition means for acquiring static information possessed by the avatar, dynamic information acquisition means for acquiring dynamic information based on the avatar's behavior, and avatar information storage means for storing the static and dynamic information associated with the avatar. The information management device is characterized in that it is equipped with avatar information storage means for storing the static and dynamic information associated with the avatar.

### PRIOR ART DOCUMENT

### Patent Documents

Patent Document 1: Patent Publication No. 2011-216073

### SUMMARY

### Problem to be Solved by the Invention

However, the inventor recognized that the following disadvantages exist in the above embodiment. Either one of them can enter the conversation mode by left-clicking on the other corporate avatar. However, in a conversation of three or more people conducted in the real world, while conversing with the person of one's own choice, one can also listen to the sounds made by the person not of one's choice. Conventional technologies cannot satisfactorily reproduce human conversations that take place in the real world in a virtual space or online meeting system.

### Means to Solve the Problem

The present disclosure provides an operating system for a virtual space or online meeting system, which is equipped with selection means for selecting any user in communication with two or more users, and output means for outputting any sound source only to the selected user.

### Effects of the Invention

In this configuration, any sound source can be output only to any user. Therefore, when there are multiple users communicating, an arbitrary sound source can be output only to the selected user. Therefore, it is possible to reproduce a conversational world that is faithful to the real world.

These and other aspects, features, and advantages of the present disclosure will become apparent from the following detailed written description of preferred embodiments and modes taken in conjunction with the following drawings, variations and modifications thereof may be implemented without departing from the spirit and scope of the novel concepts of the present disclosure.

### BRIEF DESCRIPTION OF THE DRAWINGS

FIG. 1 Diagram of a function block diagram according to one or more embodiments

FIG. 2 Diagram of a function block diagram according to one or more embodiments

### DETAILED DESCRIPTION OF PREFERRED EMBODIMENTS

In the following disclosure, many different embodiments and examples are provided to implement different features of the subject matter presented. In order to make this disclosure plain, specific examples of components and arrangements are described below. Of course, these are merely examples and are not intended to be limiting. For example, the structure in which the first feature is covered by or in contact with the second feature to be described subsequently includes embodiments in which the first and second features are formed in direct contact, as well as embodiments in which additional features are formed between the first and second features to prevent direct contact between the first and second features. The embodiments may include embodiments in which the first feature and the second feature are not in direct contact. In addition, reference numbers and/or letters may be repeated in various examples in this disclosure. Such repetition is for brevity and clarity and does not, in and of itself, require that there be a relationship between the various embodiments and/or configurations described. Furthermore, when describing a first element as being “connected” or “coupled” to a second element, such a description includes embodiments in which the first element and the second element are directly connected or coupled to each other, as well as embodiments in which the first element and the second element are indirectly connected or coupled to each other with one or more other elements interposed between them The description also includes embodiments in which the first element and the second element are indirectly connected or coupled to each other with one or more other elements interposed therebetween. As used herein, the description “at least one of” encompasses all variations illustrated. For example, the statement “comprises at least one of! , B, or C)” is synonymous with “consisting of A, B, C and combinations thereof. And it embraces all possible variants of A, B, C, A+B, A+C, B+C, and A+B+C.

This section describes the working system of a virtual space or online meeting system. As an example, we take the Metaverse as an example, but the effects in this disclosure are not limited to the Metaverse, and can be demonstrated in any virtual space or online meeting system.

The following embodiments can be taken for the actuation method used in at least one or more embodiments. The following description is taken from JP 6456303, which describes well at least one or more embodiments.

As used herein, the term “computer,” as known in the art, includes a processor, memory, such as a hard drive, disk drive or flash drive or memory stick, or other non-transient computer readable medium or non-transient storage device and at least one information storage/retrieval device, such as a keyboard, mouse, point and touch device, touch screen, or microphone, and a display structure, such as a well-known computer screen, as outlined. In addition, the computer may include one or more network connections, such as wired or wireless connections. As is known in the art, such a computer or computer system may include more or less of those enumerated above, including, for example, but not limited to tablet computers and smart devices, and other electronic media and electronic devices.

As used herein, the term “cloud” or “cloud computing” refers to centralized and virtualized computing facilities where all computing resources are shared. It can no longer refer to a specific machine for an application system or subsystem, as they are all in the “cloud.

As used herein, the term “Distributed Internet Service System” refers to a distributed Internet service platform that transforms Internet applications for execution in various computing environments. Server/Asset Distribution Server, and then deliver Internet applications, including content, data and logic, to whatever extent appropriate, and along the network, via the Component Distribution Server/Asset Distribution Server. Through the DIS, Internet applications are hosted and centrally managed with services based on each user's needs, maintaining their integrity while being cached locally on the user's device or nearby location. Web-enabled computing devices can be upgraded with DIS software to become DIS-enabled to enjoy and run distributed Internet services. (End of quote)

The following embodiment of the method of operation used in at least one or more embodiments can be taken for conventional Internet methods that do not use the distributed Internet. The following description is taken from JP7113047, which describes at least one or more embodiments well.

The communication method is not limited and may include short-range wireless communication between devices as well as communication methods using communication networks that the network 170 may include (mobile communication networks, wired Internet, wireless Internet, broadcasting networks, satellite networks, etc., as examples). For example, network 170 can be a personal area network (PAN), local area network (LAN), campus area network (CAN), metropolitan area network (MAN), wide area network), a broadband network (BBN), the Internet, or any one or more of these networks. In addition, network 170 may include any one or more of network topologies including, but not limited to, bus networks, star networks, ring networks, mesh networks, star bus networks, tree or hierarchical networks, etc. There are no

Servers 150 and 160 may be implemented by one or more computer devices that communicate via network 170 with a plurality of electronic devices 110, 120, 130, 140, respectively, to provide instructions, code, files, content, services, and the like. For example, server 150 may be a system that provides a first service to a plurality of electronic devices 110, 120, 130, 140 connected via network 170, and server 160 may also be a system that provides a second service to a plurality of electronic devices 110, 120, 130, 140 connected via network 170. The system may be a system that provides the second service to a plurality of electronic devices 110, 120, 130, 140 connected via the network 170. As a more specific example, the server 150, through an application, which is a computer program installed and executed in the plurality of electronic devices 110, 120, 130, 140, may provide a service (such as an automatic response service, as an example) intended by the application as a first The service may be provided to the plurality of electronic devices 110, 120, 130, 140 as a service. As another example, the server 160 may provide as a second service the distribution of files to the plurality of electronic devices 110, 120, 130, 140 for installation and execution of the application described above. Processors 212 and 222 may be configured to process the instructions of the computer program by performing basic arithmetic, logic, and input/output operations. The instructions may be provided to processors 212, 222 by memory 211, 221 or communication modules 213, 223. For example, processors 212, 222 may be configured to execute instructions received in accordance with program code recorded in a recording device such as memory 211, 221.

The communication modules 213 and 223 may provide functions for the electronic device 110 and the server 150 to communicate with each other via the network 170, or the electronic device 110 and/or the server 150 may communicate with other electronic devices (as one example, the electronic device 120) or other servers (as one example, the server 160) and may provide functionality for communicating with each other. As an example, a request generated by the processor 212 of the electronic device 110 according to program code recorded in a recording device such as memory 211 may be communicated to the server 150 via the network 170 under the control of the communication module 213. Conversely, control signals, instructions, content, files, etc. provided in accordance with the control of the processor 222 of the server 150 may be received by the electronic device 110 through the communication module 213 of the electronic device 110 via the communication module 223 and the network 170. For example, the control signals, instructions, content, files, etc. of the server 150 received through the communication module 213 may be communicated to the processor 212 and memory 211, and the content, files, etc. may be stored on a recording medium (non-transient recording device as described above) that the electronic device 110 may further include The content may be recorded.

The input/output interface 214 may be a means for interfacing with input/output devices 215. For example, input devices may include devices such as keyboards, mice, microphones, cameras, etc., while output devices may include devices such as displays, speakers, haptic feedback devices, etc. As another example, input/output interface 214 may be a means for interfacing with a device that integrates functions for input and output into one, such as a touch screen. The input/output device 215 may consist of the electronic device 110 and one device. The input/output interface 224 of the server 150 may be a means for interfacing with a device for input or output (not shown) that connects to or can be included by the server 150. As a more specific example, as the processor 212 of the electronic device 110 processes the instructions of the computer program loaded into the memory 211, service screens or content composed using data provided by the server 150 or the electronic device 120, through the input/output interface 214 may be displayed on the display.

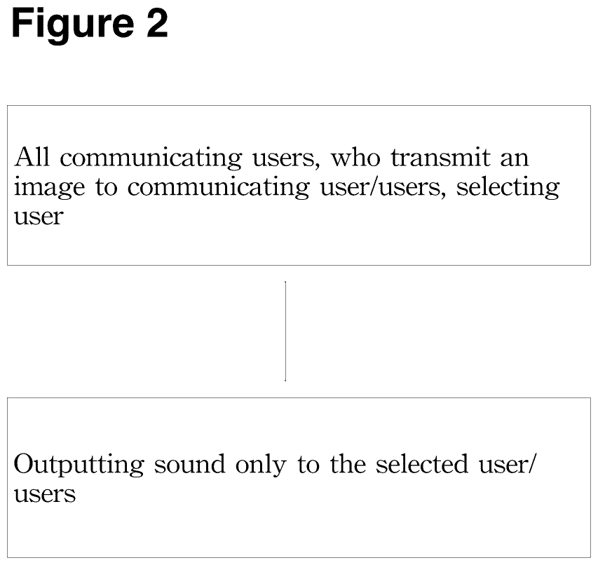

In other embodiments, the electronic device 110 and server 150 may include more components than those in FIG. 2. However, it is not necessary to clearly show most conventional technical components in the figure. For example, the electronic device 110 may be realized to include at least some of the input/output devices 215 described above, and may further include other components such as transceivers, cameras, various sensors, databases, etc. As a more specific example, if the electronic device 110 is an AI speaker, various components such as various sensors, camera modules, various physical buttons, buttons utilizing touch panels, input/output ports, vibrators for vibration, etc. that are typically included by AI speakers may be further realized to be included in the electronic device 110. (End of quote)

The equipment is described below. According to at least one embodiment, the user terminal comprises a control unit, RAM, storage unit, graphics processing unit, communication interface, and interface unit, each connected by an internal bus. According to at least one embodiment, the control section comprises a CPU and ROM. The control section executes programs stored in the storage section to control the user terminal. RAM is the work area of the control section. The storage section is a storage area for programs and data. The control section reads programs and data from RAM and processes them. The control section outputs drawing instructions to the graphics processing section by processing the programs and data loaded into RAM. According to at least one embodiment, the graphics processing section is connected to the display section. The display section has a display screen. When the control unit outputs drawing commands to the graphics processing unit, the graphics processing unit outputs video signals to display images on the display screen. Here, the display section may be a touch panel with a touch sensor. This touch panel of the display section functions as an input section. According to at least one embodiment, the communication interface can be connected to a communication network by wireless or wired means, and can send and receive data to and from the server device via the communication network. Data received via the communication interface is loaded into RAM and processed by the control unit. An external memory (e.g., SD card) is connected to the interface section.

According to at least one embodiment, the user terminal is not limited to a computer device with a display screen and input section. User terminals include, for example, conventional cell phones, tablet terminals, smartphones, desktop and notebook personal computers, etc. VR goggles, i.e., a screen attached to a frame (or headset) fixed or attached to the head by a strap (or two display panels, one for each eye) may also be used. The user terminal has an audio output. According to at least one embodiment, the user terminal is capable of communication connection with the server device via a communication network. The communication connection can be made via the communication network to transmit information or receive information. According to at least one embodiment, the server device has at least a control unit, a RAM, a storage unit, and a communication interface, each connected by an internal bus. According to at least one embodiment, the control section comprises a CPU and ROM and executes a program stored in the storage section to control the server device. The control section also has an internal timer for timekeeping; RAM is the work area of the control section. The storage section is a storage area for storing programs and data. The control section reads programs and data from RAM and performs program execution processing based on information received from the user terminal and other information.

Metaverse will be explained. According to at least one embodiment, a metaverse is a mechanism that allows users to create and act as their own avatars in a virtual space on the Internet. Another feature of the metaverse is the ability to interact with other users in the form of avatars and have unrealistic experiences. Let me explain about objects. Objects can exist at any coordinates in the virtual space. Avatars are a type of object and can exist at any coordinates in the virtual space.

This section describes the virtual space. According to at least one embodiment, an example of how to create a virtual space can be found in Patent Document 1, which is easily understood by those skilled in the art and is cited below.

The overall system consists of a public 3D virtual space provider site, a private 3D virtual space provider site, a client site, and a user site. The public 3D virtual space provider site is a site operated by a provider to provide 3D virtual space to an unspecified number of or contracted users. For example, Second Life (registered trademark of Linden Lab) operated by Linden Lab, Inc. of the United States falls under this category. This public 3D virtual space provider site consists of a public 3D virtual space management server, a user connection management server, a user authentication server, and a log management server.

The public three-dimensional virtual space management server has a public object DB (database) and a public virtual space DB (database) connected externally, respectively. Then, the three-dimensional virtual space is constructed inside the public three-dimensional virtual space management server using the data in the above two DBs. The user connection management server manages connections with user PCs so that users can perform desired activities in the public three-dimensional virtual space. The user authentication server authenticates users from their IDs, passwords, etc., and permits access to the public three-dimensional virtual space. The log management server 14 is configured to take records of the user's activities in the public three-dimensional virtual space. Next, the private three-dimensional virtual space provider site 2 is described. This private three-dimensional virtual space provider site 2 is a site operated by a provider to provide private three-dimensional virtual space to contracted client companies.

Client companies can use the private three-dimensional virtual space as an intraverse, CRM, SCM, etc. space by contract. This private three-dimensional virtual space provider site 2consists of a private three-dimensional virtual space management server 21, a user connection management server 22, a user authentication server 23, and a log management server 24. The private 3D virtual space management server 21 has a private object DB (database) 25 and a private virtual space DB (database) 26 connected externally, respectively. The data in the above two DBs are used to construct a three-dimensional virtual space 27 inside the private three-dimensional virtual space management server 21. The user connection management server 22 manages connections with user PCs so that users can perform desired activities in the private three-dimensional virtual space. Users include internal users of the client company and users (individuals and companies) in a position to do business with the client company. The user authentication server 23 authenticates the user from the user's ID, password, etc., and permits access to the public three-dimensional virtual space. The log management server 24 is configured to take records of the user's activities in the public three-dimensional virtual space.

Next, client site 3 is described. Client site 3 is based on a corporate intranet and consists of an ERP server 31 for mission-critical systems, a document management server 32 for information systems, a groupware server 33 that includes e-mail, a scheduler and workflow, a multifunction printer (MFP) 34 and many personal computers (PCs) 35 for users in the company. PCs (PCs) 35, which are connected to a LAN 36. This LAN 36 is connected to the Internet 5 mentioned above. Next, user site 4 is described. This user site 4 is an unspecified user for a public 3D virtual space provider or a private 3D virtual space provider, and consists of a plurality of personal computers (PCs) 41 and multifunctional machines 42, etc., for its contracted users. These PCs 41 are connected to the Internet 5. Next, FIG. 2 is used to describe the three-dimensional virtual space office 50 used in this implementation. The three-dimensional virtual space office 50 is formed 27 in the three-dimensional virtual space inside the private three-dimensional virtual space management server 21 of the above private three-dimensional virtual space provider site 2, where avatars of users inside client companies or users in a position to do business with client companies are 50 constitute a three-dimensional virtual space office for working.

The personal computers (PCs) 51 of the users of the three-dimensional virtual space office 50are connected to the LAN 36 of the three-dimensional virtual space client site 3. The three-dimensional virtual space client site 3 contains, as well as real-world clients (not shown), an ERP server 31 for mission-critical systems, a document management server 32 for information systems, a groupware server 33 that includes e-mail, scheduler and workflow, a multifunction printer-like multifunction printer (MFP) 34 and a company They consist of a number of personal computers (PCs) 35 for users, which are connected to a LAN 36. This LAN 36 is connected to the Internet 5 mentioned above. The three-dimensional virtual space office 50 and the three-dimensional virtual space client site 3 are all virtual. FIG. 3 shows a scene of a virtual office (or virtual exhibition hall) 60 in the three-dimensional virtual space 27 inside the private three-dimensional virtual space management server 21 of the private three-dimensional virtual space provider site 2. The codes 61, 62 (62a, 62b), 63 (63a to 63e) indicate corporate avatars. All other images that are not signed but represent human figures are corporate avatars. The corporate avatar has the necessary information registered in the private object DB25 connected to the private three-dimensional virtual space management server 21. The virtual office 60 is an exact replica of an actual office in the real world in the virtual world. The information of this virtual office 60 is stored in the first storage method 25A in the private object DB25, as shown in FIG. 4. The virtual office information can be registered for each organization within a company. By displaying the company's organizations schematically in a tree, you can instantly jump to the organization you want to go to. This kind of organization tree information can also be stored in the first storage means 25A. In the case of virtual exhibition halls, similarly, by registering exhibition hall information in advance, virtual exhibition halls can be set up on specific islands in the metaverse. (End of quotation above)

The state of being in communication with two or more users is described. According to at least one embodiment, the state of being in communication with two or more users refers to a state in which two or more users can send and receive any information through an online connection. According to at least one embodiment, these sending and receiving take place in a virtual space or in an online meeting system.

This section describes the selection means for selecting any user. According to at least one embodiment, it is suitable if the user can select one or more of the users displayed in the virtual space or online meeting system using a user terminal. The information of the selected user can have a communication connection with the server device via a communication network. The information can be sent or received through the communication connection via the communication network.

This section describes an output means that outputs an arbitrary sound source only to selected users. According to at least one embodiment, it is suitable to have a function that allows a user to send an arbitrary sound source to one or more selected users using a user terminal and have the sound source output at that user's user terminal. As an example, the server identifies the user to whom the sound source should be sent based on the information of the selected user. The server sends the sound source to be sent to the user terminal of the selected user via the communication network. The user terminal that receives the transmitted sound source outputs the sound source. An example of a sound source is the user's voice. An example of a sound source is sound data transmitted by the user. According to at least one or more of the above embodiments, any information, not limited to sound sources, can be transmitted to the user in one or more of the above ways.

In this disclosure, according to at least one embodiment, “output means that outputs any sound source only to the selected user” is synonymous in technical characteristics with “output means that does not output any sound source only to the selected user”.

According to at least one embodiment, when a user terminal that receives a transmitted sound source outputs that sound source, there is a means to change the intensity of the sound of the sound source. A user who receives a transmitted sound source operates that user terminal to input information supporting the intensity of the received sound source. The control unit of the user terminal controls the intensity of the sound of the received sound source based on that information and outputs the sound source from the output unit.

According to at least one embodiment, in a state of communication with two or more users, all communicating users have selection means to select any user, output means to output any sound source only to the selected user, and reception means to receive information transmitted from a non-selecting user, The system is equipped with the following. The user recognizes the users communicating by one or more of the above methods and selects any user. The user selects a user, and any information is transmitted to and output to that user's terminal by one or more of the methods described above. On the other hand, from the user who is not selected, the information transmitted by that user is received. In at least one or more embodiments, it is possible to construct an online meeting system or virtual space in which sound information such as one's own voice is sent to the selected user, and sound information such as one's own voice is not sent to the non-selected user, but instead the voice or video sent by the non-selected user is received. In one or more embodiments, this information is not limited to sound, but can be images, video, or any other information.

According to at least one embodiment, in a state of communication with two or more users, all communicating users have means of selection to select any user among them while transmitting images to the communicating users, and output means to output any sound source only to the selected user. The user transmits the video to all of the communicating users in one or more of the above methods. On the other hand, the user selects a user by one or more of the above methods and transmits an arbitrary sound source only to that user and outputs it to that user terminal.

Avatars in the Metaverse operating system of the patent document 1 register information such as age, gender, body type (thin, obese, or medium), height, and skin color in advance. However, the inventor recognized that the above embodiment has the following disadvantages. In the real world, skin color changes according to human physiological conditions (including health and disease conditions), and facial expressions and postures change. Conversations in the real world are conducted by detecting those biological information. Conventional technologies cannot reflect such biometric information in the avatar's graphics. Conventional technologies cannot satisfactorily reproduce human conversations in the real world in a virtual space or online meeting system.

This section describes the acquisition means for acquiring biometric information of the user. According to at least one embodiment, the acquisition means uses biosensors. Examples of biosensors include a blood pressure meter, a pulse rate sensor, a thermometer, an electromyogram measuring device, an EEG measuring device, an eye movement measuring device, and a pupil movement measuring device. According to at least one embodiment, these devices are used to acquire the user's biometric information. Other devices consist of genetic information analysis equipment. The user's DNA may be collected and biometric information such as nationality, gender, skin color, etc. may be obtained based on the DNA information.

This section describes a means of changing the graphics of user-operated objects in a predetermined manner according to biometric information. According to at least one embodiment, the user terminal is capable of communicating and connecting the acquired biometric information to the server device via a communication network. The server device accepts the biometric information acquired by the acquisition means. The control unit of the server device generates command information to change the graphics of the user-operated object in a predetermined manner according to the biometric information. The command information is transmitted to the user terminal via the communication network. The user terminal changes the graphics of the object in question based on the command information and outputs the information at the output section. For example, it is suitable to increase or decrease the percentage of red in the color rendering of the skin color according to the numerical value of the user's body temperature. For example, it is suitable to increase or decrease the percentage of red in the skin color rendering in accordance with the degree of deviation of the user's body temperature from the average value over a given period. For example, if the amount of brain wave activity is less than the user's average activity in a given period of time, the avatar may be displayed to show a tired expression. For example, if the user's pulse rate increases above the user's average for a given period of time, or if EMG potentials are measured in certain areas of the facial muscles, the avatar may be displayed to show a particular expression (e.g., joy, anger, confusion). According to at least one embodiment, the object graphics are changed in a predetermined manner according to biometric information.

In the conversation mode in the Metaverse operating system of the patent document 1, corporate avatars can enter the conversation mode by either one of them left-clicking on the other corporate avatar. However, the inventor recognized that the above embodiment has the following disadvantages. In the real world, users have the opportunity to exchange business cards at the same time. The business card may contain contact information with which the user can be contacted. Conventional technology did not have a mechanism for users to exchange information regarding contact information among themselves in a virtual space or in an online meeting system. Therefore, conventional technologies cannot satisfactorily reproduce human conversations that take place in the real world in a virtual space or online meeting system.

This section describes a means for acquiring user information to acquire arbitrary information about the user's contact information. According to at least one embodiment, the server device receives, via the network, information about contact information transmitted by the user from the user terminal. As an example of the information about the contact, the information includes one or more of the user's name, information identifying a destination of the user that enables communication by electromagnetic means, and the like. An example of the information about the contact includes one or more of a user ID in the virtual space (including the metaverse), a user name, and information about the contact of the user.

This section describes the transmission means by which user information is transmitted to other users. According to at least one embodiment, the server device identifies other users, with whom the user is communicating. The server device transmits the information about the contacts transmitted from the user terminal to the other user terminals via the network. It is also suitable if the information to be transmitted can be arbitrarily specified by the user. For example, when a user has multiple user IDs, user names, and user contact information in the virtual space (including the metaverse), it is suitable if the user can specify any one or more of them.

The configurations disclosed in each of the above-described embodiments may be applied in combination with the configurations disclosed in other embodiments, as long as no contradiction arises. With respect to other configurations, the embodiments disclosed herein are in all respects mere examples. Accordingly, various modifications can be made as appropriate within the scope that does not depart from the intent of the present disclosure.

The following is an overview of the operating system of the virtual space or online meeting system described above.

An actuation system for a virtual space or an online meeting system, which is equipped with selection means for selecting any user while in communication with two or more users, and output means for outputting any sound source only to the selected user.

A system for a virtual space or an online meeting, said system comprising:
In a state of communication with two or more users,
A selection means by which all communicating users select user; and
An output means that outputs sound only to the selected user/users; and
A receiving means that receives information transmitted by the non-selected user/users.

A system for a virtual space or an online meeting, said system comprising:
In a state of communication with two or more users,
A selection means by which all communicating users, who transmit an image to communicating user/users, select user; and
An output means that outputs sound only to the selected user/users.

A method for a virtual space or an online meeting, said method comprising:
In a state of communication with two or more users,
All communicating users selecting user; and
Outputting sound only to the selected user/users; and
Receiving information transmitted by the non-selected user/users.

A Method for a virtual space or an online meeting, said method comprising:
In a state of communication with two or more users,
All communicating users, who transmit an image to communicating user/users, selecting user; and
Outputting sound only to the selected user/users.

In the above configuration, any sound source can be output only to any user. Therefore, when there are multiple users communicating with each other, any sound source can be output only to the selected user. Thus, it is possible to reproduce a conversational world that is faithful to the real world. For example, in a virtual space (including the metaverse), when multiple people are having a meeting, it is possible for participant B and participant C to converse so that only participant B and participant C can hear each other while listening to the voice being uttered by participant A. In this example, participant A has selected participant B and participant C, participant B has selected participant C, and participant C has selected participant B. Note that in a real meeting, there could be a situation in which Participant A, who is a guest speaker, is giving a speech, while Participant B and Participant C, who are in the next seat, who are audience members, are exchanging opinions in a whisper (i.e., the content of the conversation between Participant B and Participant C is not heard by Participant A). Therefore, this configuration makes it possible to reproduce such a real-world meeting situation online.

An actuation system for a virtual space or online meeting system with means for acquiring user information and transmitting user information to other users while in communication with the user, including means for acquiring arbitrary information about the user's contact information and transmitting the user information to other users.

This configuration allows a mechanism for exchanging information about contacts among users in a virtual space or online meeting system.

A system for operating a virtual space equipped with acquisition means for acquiring biometric information of a user and change means for changing the graphics of an object in a predetermined manner according to the biometric information.

In this configuration, the user's biometric information can be reflected in the graphics of objects (including avatars), enabling conversation that is sensitive to the user's biometric information.

The present disclosure described above can also be used as a system as a method. That is, the “system for operating a virtual space or online meeting system” can be implemented as a method as “a method for operating a virtual space or online meeting system”.

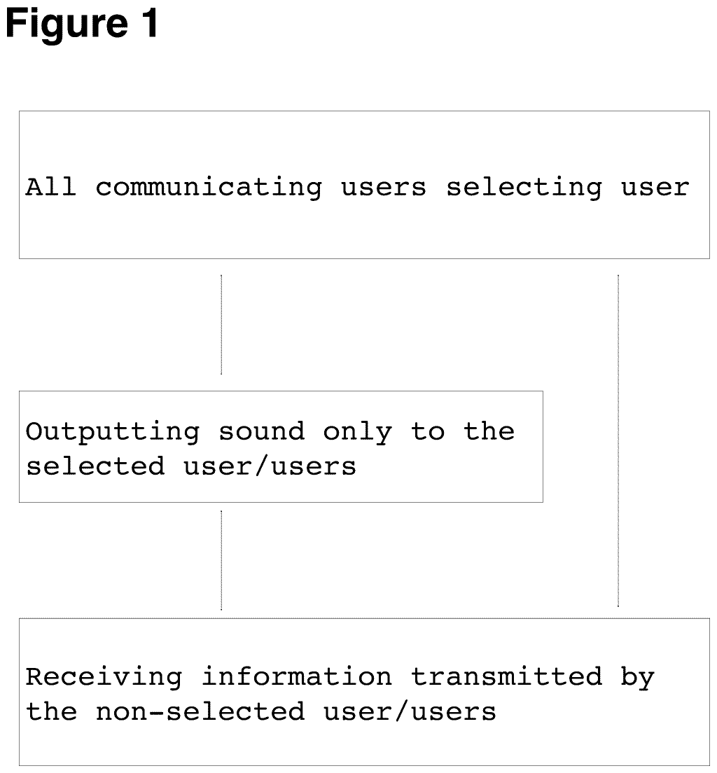

FIG. 1 is described below. FIG. 1 is a function block diagram according to one or more of the embodiments described above. In at least one example, a schematic of the example described in paragraphs 0076 and 0078, for example, is shown. Arrows indicate that the respective steps can be used in any order in at least one example. Arrows indicate that in at least one example, the examples are provided with the respective means.

FIG. 2. FIG. 2 is a function block diagram according to one or more of the above embodiments. In at least one example, a schematic of the example described in paragraphs 0077 and 0079, for example, is shown. Arrows indicate that the respective steps can be used in any order in at least one example. Arrows indicate that in at least one example, the examples are provided with the respective means.

The operating system of the virtual space or online meeting system for this disclosure should be able to achieve at least one of each of the effects described above.

1. (canceled)

2. A system for a virtual space or an online meeting, said system comprising:
In a state of communication with two or more users,
A selection means by which all communicating users, who transmit an image to communicating user/users, select user; and
An output means that outputs sound only to the selected user/users.

3. A method for a virtual space or an online meeting, said method comprising:
In a state of communication with two or more users,
All communicating users selecting user; and
Outputting sound only to the selected user/users; and
Receiving information transmitted by the non-selected user/users.

4. A Method for a virtual space or an online meeting, said method comprising:
In a state of communication with two or more users,
All communicating users, who transmit an image to communicating user/users, selecting user; and
Outputting sound only to the selected user/users.
